(19) United States
(12) Patent Application Publication
(10) Pub. No.: US 2019/0045546 A1
(43) Pub. Date: Feb. 7, 2019

(54) Collision Handling of Ultra-Reliable Low Latency Communication (URLLC) and Enhanced Mobile Broadband (eMBB) Uplink (UL) Transmission

(71) Applicant: MEDIATEK INC., Hsinchu (TW)

(72) Inventor: Xiu-Sheng Li, Hsinchu (TW)

(21) Appl. No.: 16/053,797

(22) Filed: Aug. 3, 2018

Related U.S. Application Data
(60) Provisional application No. 62/541,179, filed on Aug. 4, 2017.

(51) Int. Cl. H04W 74/08; H04L 5/00; H04W 72/12; H04L 1/18

(52) U.S. Cl. CPC H04W 74/0825; H04L 5/0073; H04L 1/1812; H04W 72/1215; H04W 72/1268; H04L 5/0055

(57) ABSTRACT

Methods and apparatus are provided for URLLC and eMBB collision resolution. In one novel aspect, the UE initiates a collision resolution such that an URLLC uplink transmission colliding with the scheduled eMBB UL transmission can be carried out successfully. The UE modifies the scheduled eMBB UL transmission based on the collision resolution. In one embodiment, the URLLC UL transmission is for the same UE and the UE punctures the UL eMBB transmission based on predefined rules and transmitting both the UL URLLC and the UL eMBB. In another embodiment, the URLLC UL transmission colliding with the eMBB is from another UE. In one embodiment, the collision resolution command is embedded in a downlink control information (DCI) specifying a TPC offset larger than 3dB for an HARQ-ACK feedback or for a PUSCH transmission or a stop indicator to stop the UL eMBB transmission through one layer-1 (L1) signaling.

### CROSS REFERENCE TO RELATED APPLICATIONS

This application claims priority under 35 U.S.C. § 119 from U.S. Provisional Application No. 62/541,179 entitled “MECHANISM ON COLLISION HANDLING OF URLLC AND EMBB UL TRANSMISSION” filed on Aug. 4, 2017, the subject matter of which is incorporated herein by reference.

### TECHNICAL FIELD

The disclosed embodiments relate generally to wireless communication, and more particularly, to methods and apparatus for collision handling of ultra-reliable low latency communication (URLLC) and enhanced mobile broadband (eMBB) uplink (UL) transmission.

### BACKGROUND

The introduction of the fifth generation (5G) wireless communication standard is seen to provide extensive improvements for the Long Term Evolution (LTE) mobile telecommunication systems. With the increasing demand for higher system capacity, radio access technology (RAT) is one area for improvement. The new radio (“NR”) is developed for the next generation 5G wireless system. The NR 5G standard is to include new features including the enhanced Mobile Broadband (eMBB), the ultra-reliable low latency communications (URLLC), and the massive Machine Type communications (mMTC).

The objective of the eMBB is to maximize the data rate. The eMBB supports stable connections with very high peak data rate. It allows the service to schedule wireless resources to the eMBB devices such that no two eMBB devices access the same resources simultaneously. The URLLC service, however, is designed to support low-latency transmission of small payloads requiring very high reliability, which is typically activated by emergency services such as alarms. When eMBB is already scheduled for uplink (UL) transmission, due to the urgency of the URLLC traffic, the NR network may still schedule the transmission of URLLC, which creates collision between the prior scheduled eMBB and the URLLC transmission.

Improvement and new design are needed to resolve the potential collision between the eMBB and the URLLC.

### SUMMARY

Methods and apparatus are provided for URLLC and eMBB collision resolution. In one novel aspect, the UE is scheduled with an eMBB UL transmission and subsequently receives a collision resolution command from the NR wireless network such that an URLLC uplink transmission can be carried out successfully, wherein the URLLC UL transmission collides with the scheduled eMBB UL transmission. The UE modifies the scheduled eMBB UL transmission based on the collision resolution command. In one embodiment, the URLLC UL transmission is for the same UE. In one embodiment, the UE transmission power is high enough to support both the UL eMBB and the UL URLLC transmissions, and wherein the modified UL eMBB transmission is puncturing the UL eMBB transmission based on predefined rules and transmitting both the UL URLLC and the UL eMBB. In another embodiment, the UE transmission power is not high enough to support both the UL eMBB and the UL URLLC, and wherein the modified UL eMBB transmission is one selecting from a modified-eMBB-transmission group comprising allocating enough power for the UL URLLC transmission while using remaining transmission power for the eMBB transmission, puncturing the UL eMBB transmission, and scaling down transmission power for both the UL URLLC transmission and the UL eMBB transmission. In one embodiment, the URLLC UL transmission colliding with the eMBB is from another UE. In one embodiment, the collision resolution command is embedded in a downlink control information (DCI) specifying a TPC offset larger than 5dB for an HARQ-ACK feedback or for a PUSCH transmission. In another embodiment, the collision resolution command is a stop indicator to stop the UL eMBB transmission within a colliding time-frequency resource, and wherein the stop indicator is carried by one layer-1 (L1) signaling selecting from a L1 signaling group comprising a common downlink control information (DCI) and a new physical (PHY) channel.

In another novel aspect, the gNB schedules an eMBB UL transmission a user equipment (UE) in a new radio (NR) wireless network and subsequently detects a collision between a UL URLLC and the scheduled eMBB transmission. The gNB creates a collision resolution such that the URLLC UL transmission can be carried out successfully and transmits a collision resolution command to the UE.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary NR wireless communication network with UEs supporting 5G features including eMBB and URLLC in accordance with embodiments of the current invention.

FIG. 2 illustrates exemplary diagrams of the traffic collision handling for the NR network in accordance with embodiments of the current invention.

FIG. 3 illustrates exemplary diagrams of collision of URLLC and eMBB UL transmission from one UE in accordance with embodiments of the current invention.

FIG. 4 illustrates exemplary diagrams of collision of URLLC and eMBB UL transmission from one UE when PUSCH of URLLC collides with PUSCH of eMBB in accordance with embodiments of the current invention.

FIG. 5 illustrates exemplary diagrams of collision of URLLC and eMBB UL transmission from one UE when grant-free PUSCH of URLLC collides with PUSCH of eMBB in accordance with embodiments of the current invention.

FIG. 6 illustrates exemplary diagrams of collision of URLLC and eMBB UL transmission from different UE and stop indicator using common DCI is used in accordance with embodiments of the current invention.

FIG. 7 illustrates exemplary diagrams of collision of URLLC and eMBB UL transmission from different UE and stop indicator using a new PHY channel is used in accordance with embodiments of the current invention.

FIG. 8 illustrates an exemplary flow chart of the UE URLLC and eMBB collision resolution in accordance with embodiments of the current invention.

FIG. 9 illustrates an exemplary flow chart of the gNB URLLC and eMBB collision resolution in accordance with embodiments of the current invention.

### DETAILED DESCRIPTION

Reference will now be made in detail to some embodiments of the invention, examples of which are illustrated in the accompanying drawings.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections. The making and using of the embodiments of the disclosure are discussed in detail below. It should be appreciated, however, that the embodiments can be embodied in a wide variety of specific contexts. The specific embodiments discussed are merely illustrative, and do not limit the scope of the disclosure. Some variations of the embodiments are described. Throughout the various views and illustrative embodiments, like reference numbers are used to designate like elements. Reference will now be made in detail to some embodiments of the invention, examples of which are illustrated in the accompanying drawings.

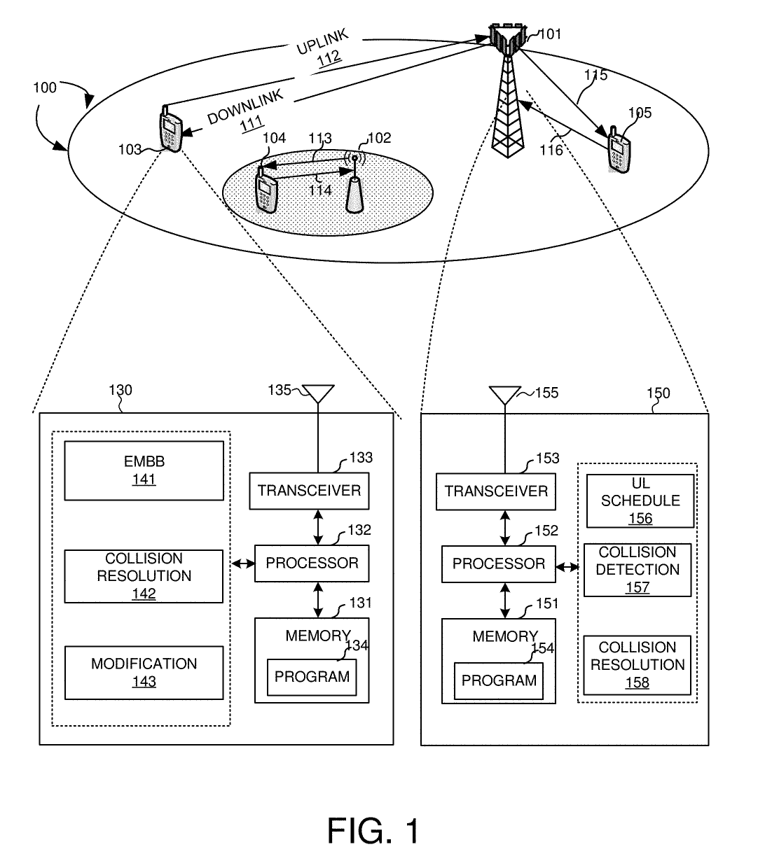

FIG. 1 illustrates an exemplary NR wireless communication network 100 with UEs supporting 5G features including eMBB and URLLC in accordance with embodiments of the current invention. Wireless communication system 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. In FIG. 1, the one or more base stations 101 and 102 serve a number of remote units/user equipment (UEs) 103, 104, and 105 within a serving area, for example, a cell, or within a cell sector. In some systems, one or more base stations are communicably coupled to a controller forming an access network that is communicably coupled to one or more core networks. The disclosure, however, is not intended to be limited to any particular wireless communication system.

Generally, serving base stations 101 and 102 transmit downlink communication signals 111 and 113 to UEs or mobile stations in the time and/or frequency domain. UEs or mobile stations 103 and 104 communicate with one or more base stations 101 and 102 via uplink communication signals 112, 114, and 116. UE or the mobile station may also be referred to as a mobile phone, laptop, and mobile workstation and so on. In FIG. 1, the mobile communication network 100 is an OFDM/OFDMA system comprising a base station eNB 101 eNB 102 and a plurality of UE 103, UE 104, and UE 105. When there is a downlink packet to be sent from the eNB to the UE, each UE gets a downlink assignment, e.g., a set of radio resources in a physical downlink shared channel (PDSCH). When a UE needs to send a packet to eNB in the uplink, the UE gets a grant from the eNB that assigns a physical uplink shared channel (PUSCH) consisting of a set of uplink radio resources. The UE can also get grant-free uplink access on PUSCH. The UE gets the downlink or uplink scheduling information from a new RAT physical downlink control channel (NR-PDCCH), which is targeted specifically to NR UEs/mobile stations and has similar functionalities as legacy PDCCH, EPDCCH and MPDCCH. The downlink or uplink scheduling information and the other control information, carried by NR-PDCCH, is referred to as downlink control information (DCI).

FIG. 1 further illustrates simplified block diagrams 130 and 150 UE 103 and eNB 101, respectively. UE 103 has an antenna 135, which transmits and receives radio signals. A RF transceiver module 133, coupled with the antenna, receives RF signals from antenna 135, converts them to baseband signals and sends them to processor 132. RF transceiver 133 also converts received baseband signals from processor 132, converts them to RF signals, and sends out to antenna 135. Processor 132 processes the received baseband signals and invokes different functional modules to perform features in UE 103. Memory 131 stores program instructions and data 134 to control the operations of UE 103.

UE 103 also includes multiple function modules that carry out different tasks in accordance with embodiments of the current invention. An eMBB circuit 141 schedules an eMBB uplink (UL) transmission in the NR wireless system. A collision resolution circuit 142 initiates a collision resolution such that an ultra-reliable low latency communications (URLLC) uplink transmission can be carried out successfully, wherein the URLLC UL transmission collides with the scheduled eMBB UL transmission. A modification circuit 143 modifies the scheduled eMBB UL transmission based on the collision resolution.

Also shown in FIG. 1 is exemplary block diagram for eNB 101. eNB 101 has an antenna 155, which transmits and receives radio signals. A RF transceiver module 153, coupled with the antenna, receives RF signals from antenna 155, converts them to baseband signals, and sends them to processor 152. RF transceiver 153 also converts received baseband signals from processor 152, converts them to RF signals, and sends out to antenna 155. Processor 152 processes the received baseband signals and invokes different functional modules to perform features in eNB 101. Memory 151 stores program instructions and data 154 to control the operations of eNB 101. eNB 101 also includes function modules that carry out different tasks in accordance with embodiments of the current invention. A UL scheduling module/circuit 156 schedules an enhanced mobile broadband (eMBB) UL transmission for a UE in the NR wireless network. A collision detection module/circuit 157 detects a collision between a UL ultra-reliable low latency communications (URLLC) and the scheduled UL eMBB transmission. A collision resolution circuit/module 158 creates a collision resolution command such that the URLLC UL transmission can be carried out successfully and transmits a collision resolution command to the UE.

Potential traffic collision may happen under different scenarios. In this application, eMBB and URLLC traffic collision are discussed as exemplary scenario. The eMBB being a prior scheduled traffic has lower priority than the later occurred higher priority URLLC traffic. It is understood by one of ordinary skills in the art that the same principle and methods apply to other traffic types with different priorities. The scenarios represent the category of a higher priority traffic, such as the URLLC, has collision with a prior scheduled lower priority traffic, such as the eMBB. Furthermore, the same method and principle apply to scenarios where a later scheduled traffic collides with a prior scheduled traffic. The prior scheduled traffic may have a higher or equal priority than the later scheduled traffic. The disclosed methods apply to these scenarios as well.

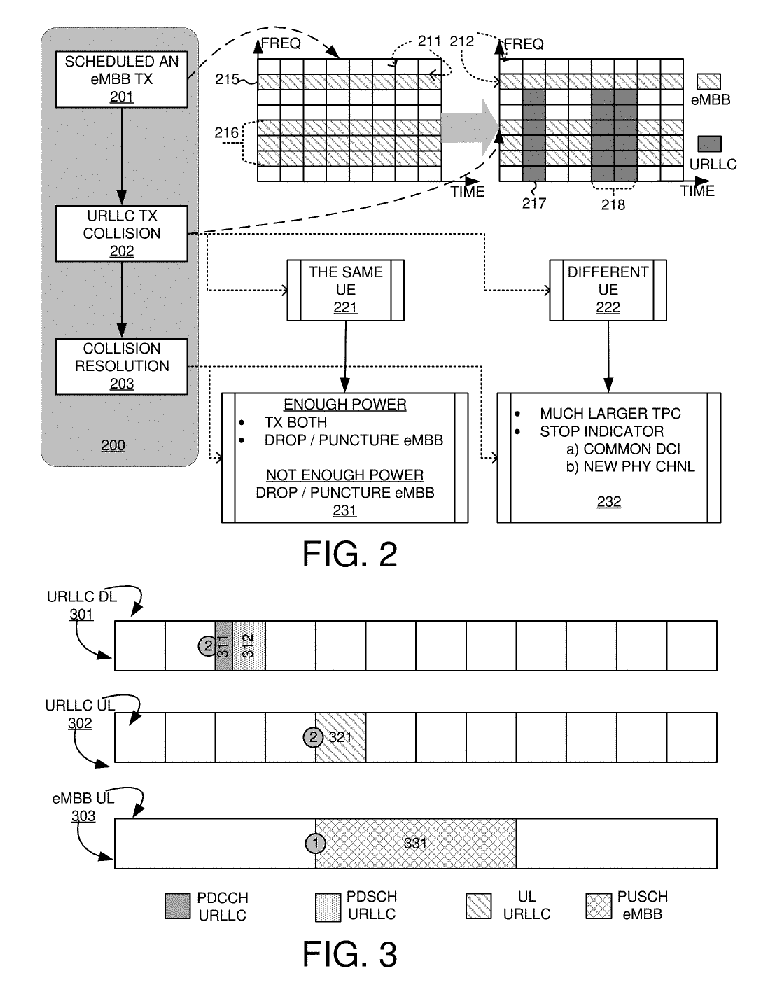

FIG. 2 illustrates exemplary diagrams of the traffic collision handling for the NR network in accordance with embodiments of the current invention. As shown procedure 200 is a top-level collision handling flow chart. At step 201, the UE is scheduled for an eMBB transmission with allocated resources. At step 202, a traffic collision happens. At step 203, a collision resolution is carried out based on predefined rules.

The eMBB services provides services of high bandwidth, such as high definition (HD) videos, virtual reality (VR) and augment reality (AR). Resource blocks 211 and 212 are exemplary resource blocks includes multiple time-frequency resource elements. An eMBB transmission is normally scheduled with resource blocks for the service such as shown in resource 211. The exemplary diagram 211 shows eMBB resources 215 and 216 are scheduled for the eMBB service. The URLLC services are designed for ultra-reliable and low latency. Upon scheduling a URLLC services, the resource blocks for the URLLC may collide with the prior scheduled eMBB resource blocks 215 and 216. An exemplary resource block 212 shows the collision of the eMBB and the URLLC. The URLLC blocks 217 and 218 collides in the time and frequency domain with resource blocks 216 of the eMBB. URLLC blocks 217 and 218 also collides in the time domain with eMBB blocks 215. In other RF configurations such as FDD and TDD, similar scenarios may occur when a higher priority traffic, such as the URLLC and a lower priority traffic, such as the eMBB, share the same bandwidth or overlap in one or more resource elements (REs). In such scenarios, the same principle and methods applies for collision resolution.

The URLLC collision with the eMBB may be from the same UE, as in scenario 221 or from the different UE, as in scenario 222. When the URLLC and eMBB are transmitting from the same UE, the collision happens when the URLLC and eMBB collide at least in the time domain. For example, when the URLLC is carried on PUSCH or PUCCH or the SR or HARQ-ACK feedback and the eMBB is scheduled on PUSCH or PUCCH. When the URLLC is transmitted from a different UE, it collides with the eMBB in another UE if there are overlapping resource elements (REs).

Upon determining the collision, the collision resolution is performed such that the URLLC transmission can be successful. If the collision comes from the same UE, action 231 applies. If the collision comes from different UE, action 232 applies. In another embodiment, a combination of the different resolution methods applies.

For collision from the same UE, if the UE has enough transmitting power to support both the URLLC and the eMBB, in one embodiment, both the URLLC and the eMBB can be transmitted. In another embodiment, the eMBB can be dropped or punctured based on predefined rules. For example, in one embodiment, the eMBB is always dropped. In another embodiment, the eMBB is dropped if demodulation reference signal (DMRS) does not show up in all partitioned duration. In one embodiment, if the overlapping happens in both the time and the frequency domain, the eMBB is punctured base on predefined puncturing rules. In one embodiment, the puncturing rule is to puncture the overlapped one or more eMBB RE. In another embodiment, if there is one or more overlapped RE within the eMBB OFDM symbol, the whole eMBB symbol is to be punctured. In yet another embodiment, if there is one or more overlapped RE within the eMBB slot, the whole eMBB slot is to be punctured.

For collision from the same UE, if the UE does not have enough transmitting power to support both the eMBB and the URLLC transmissions, one or more resolutions apply. In a first solution for collision from the same UE without enough power to support both, the eMBB uses remaining power such that the URLLC gets the desired transmission power. In one scenario, the eMBB reduces its power to the remaining power for the entire transmission. In another embodiment, the eMBB only reduces its power to the remaining power within the overlapped duration. In a second solution for collision from the same UE without enough power to support both, the eMBB is dropped/punctured based on predefined puncturing rules. The same set of puncturing rules described above applies. The puncturing rule can be configured to be the same for the both scenarios of when the UE having enough transmission power for both the URLLC and the eMBB and when the UE not having enough transmission power for both the URLLC and the eMBB. In another embodiment, the puncturing rules can be configured differently for different scenarios. The puncturing rules can be predefined or dynamically configured by the NR network or by the UE. In a third solution for collision from the same UE without enough power to support both, the transmission power is scaled down for both the URLLC and the eMBB based on power-adjustment rules. In a fourth solution, any combination of the first, second and the third solution may apply.

In a different scenario, the URLLC collision comes from one or more different UEs. In a first solution for collision from different UEs, the UE carrying the eMBB receives a much larger transmit power control (TPC) offset. In the much larger TPC offset can be 5 db or even 10 db larger. When the gNB determined that there is a collision between the URLLC UL transmission and an eMBB transmission, the gNB can specify a much larger TPC offset value using the DCI for HARQ-ACK feedback or PUSCH transmission. In a second solution for collision from different UEs, a stop indicator is sent to the UE with the eMBB to stop UL eMBB transmission within a specified time-frequency resource. In one embodiment, the stop indicator is signaled to the UE by layer one (L1) signaling. In one embodiment, the L1 signaling is the common DCI. In another embodiment, the L1 signaling is the new physical (PHY) channel.

FIG. 3 illustrates exemplary diagrams of collision of URLLC and eMBB UL transmission from one UE in accordance with embodiments of the current invention. Collision of URLLC and eMBB can occur when the PUSCH, PUCCH of URLLC collides with the eMBB from the same UE on PUSCH or PUCCH. In one example, the HARQ-ACK feedback of the URLLC collides with PUSCH of the eMBB. At step-1, the UE scheduled with eMBB UL 303 with resource blocks 331. At step-2, the UE has a URLLC PDSCH reception 311 and a corresponding HARQ-ACK feedback 312. The PUCCH HARQ-ACK of URLLC 321 collides with the PUSCH eMBB 331 in the time domain. Similar scenario occurs for FDD or TDD when the URLLC and the eMBB shares the same bandwidth. If the UE has enough transmitting power for both eMBB 331 and URLLC 321, both eMBB and the URLLC can be transmitted. The overlapping eMBB 331 is punctured based on a selected puncturing rule. If the UE does not have enough transmitting power for both eMBB 331 and URLLC 321, in one embodiment, eMBB 331 will use remaining power while the URLLC 321 uses the desired power. In another embodiment, eMBB 331 is punctured based on a selected puncturing rule. In yet another embodiment, the transmitting power for both the eMBB 331 and URLLC 321 are scaled down. A combination of the above solution can also be applied.

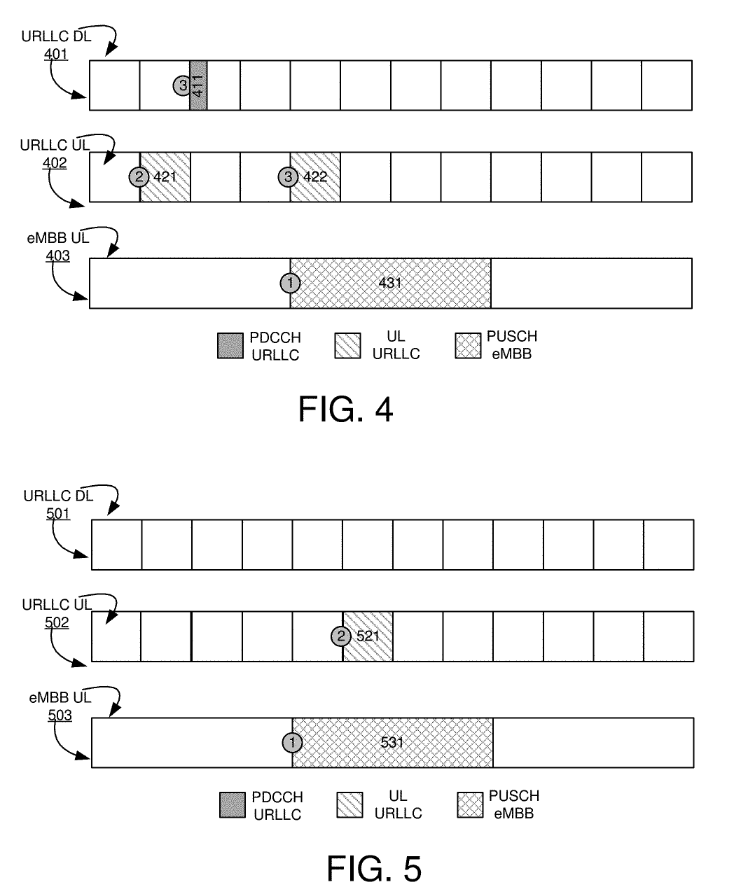

FIG. 4 illustrates exemplary diagrams of collision of URLLC and eMBB UL transmission from one UE when PUSCH of URLLC collides with PUSCH of eMBB in accordance with embodiments of the current invention. At step-1, the UE scheduled eMBB UL transmission 403 with eMBB resources 431. At step-2, due to urgency, the UE transmits SR of URLLC at URLLC UL 402 with resources 421. At step-3, the network schedules PUSCH URLLC with PDCCH 401 using resource 411. The scheduled URLLC resource 422 collides with eMBB resource 431 at least in the time domain. Such collision comes from the same UE and the same rules apply as illustrated above.

FIG. 5 illustrates exemplary diagrams of collision of URLLC and eMBB UL transmission from one UE when grant-free PUSCH of URLLC collides with PUSCH of eMBB in accordance with embodiments of the current invention. In another scenario, the URLLC transmission may use the grant-less resource of the PUSCH. At step-1, the UE is scheduled with eMBB UL 503 with eMBB resource 531. A URLLC DL 501 is configured for URLLC downlink control signals. In a grant-less scenario, however, no signals are needed. At step-2, the UE has a grant-less/grant-free opportunity. Due to urgency, the UE transmits on URLLC UL of the PUSCH 502 a URLLC with resource 521. PUSCH resource 521 for URLLC collides with PUSCH resource 531 for eMBB in the time domain. The resolution options for the same UE collision as discussed above also apply in this scenario.

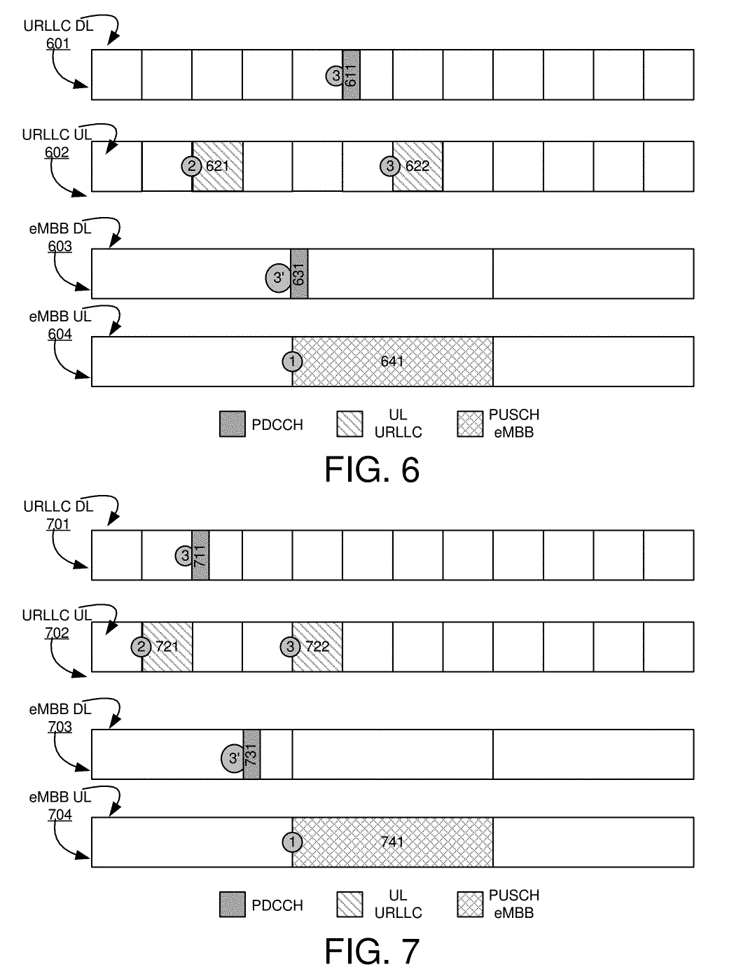

In the 5G NR system, the URLLC and eMBB collision may also come from different UEs. When the NR detects the potential collision from different UEs, eMBB transmission is modified such that the URLLC can be transmitted successfully. In one embodiment, upon detecting the collision from different UEs, the NR network specifies a much larger TPC offset and sent to the UE with URLLC. In one embodiment, the TPC offset is sent via DCI for HARQ-Ack feedback or PUSCH transmission. In another embodiment, the stop indicator is sent to the UE of the eMBB transmission to stop the UL eMBB transmission within certain time-frequency resource. FIG. 6 and FIG. 7 illustrates different examples of the stop indicator for eMBB transmission.

FIG. 6 illustrates exemplary diagrams of collision of URLLC and eMBB UL transmission from different UE and stop indicator using common DCI is used in accordance with embodiments of the current invention. At step-1, the UE is scheduled with eMBB UL 604 with eMBB resource 641. At step-2, another UE transmits one URLLC at URLLC UL 602 with resource 621. At step-3, the NR network schedules another UE a URLLC in URLLC UL 602 with URLLC resource 622 through URLLC DL 601 at using the resource 611. The URLLC UL resource 622 for another UE collides with the UE's eMBB UL resource 641. In one embodiment, upon detecting the possible collision to the scheduled eMBB, the NR network sends a stop indicator to the UE using a common DCI. At step-3′ the eMBB DL 603 is used to stop remaining UL eMBB transmission with resource 631. Upon receiving the stop indicator, the UE can stop the eMBB transmission based on a selected stop rule. The stop rules can be stop the whole band of the eMBB transmission or stop the slot of partial band of the eMBB transmission or stop the overlapping slots of the eMBB based on a predefined granularity. The stop rule can be included in the DCI or predefined or preconfigured. The stop indicator may indicate applies to the next slot as well.

FIG. 7 illustrates exemplary diagrams of collision of URLLC and eMBB UL transmission from different UE and stop indicator using a new PHY channel is used in accordance with embodiments of the current invention. In another embodiment, the new PHY channel is used to stop the eMBB transmission by sending a stop indicator. At step-1, the UE is scheduled with eMBB UL transmission 704 using resource 741. At step-2, a second UE sends a URLLC SR with URLLC UL 702 via resource 721. At step-3, the NR network schedule the second UE a PUSCH URLLC by a PDCCH of URLLC DL 701 with resource 711. Further, at step-3, the scheduled URLLC UL resource 722 for the second UE uses URLLC UL 702 and collides with eMBB resource 741. In one embodiment, upon detecting the possible collision to the scheduled eMBB, the NR network sends a stop indicator to the UE using a new PHY channel of eMBB DL 703 of resource 731. In one embodiment, the NR network may configure the UE to monitor a dedicated channel for such information periodically or by some monitoring patterns. The new PHY channel may superpose or puncturing other DL transmissions.

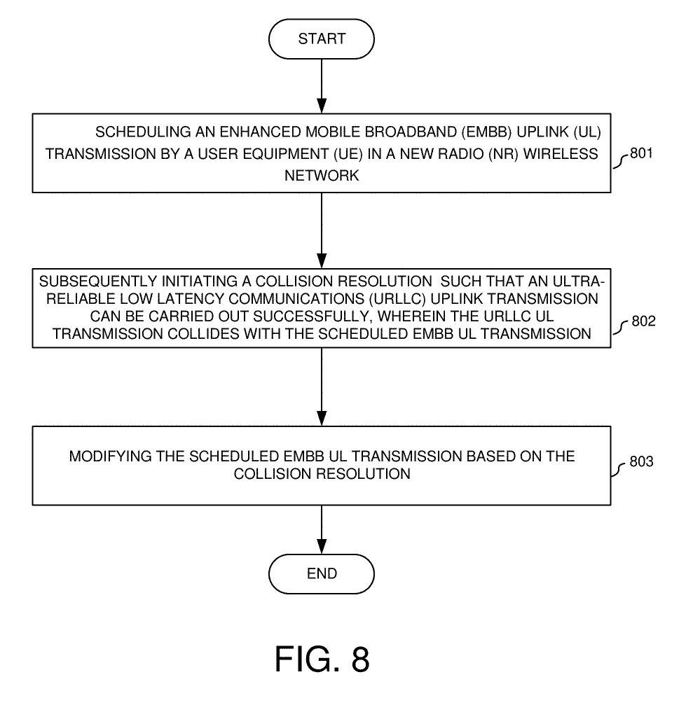

FIG. 8 illustrates an exemplary flow chart of the UE URLLC and eMBB collision resolution in accordance with embodiments of the current invention. At step 801, the UE schedules an eMBB UL transmission in NR wireless network. At step 802, the UE subsequently initiates a collision resolution such that an URLLC uplink transmission can be carried out successfully, wherein the URLLC UL transmission collides with the scheduled eMBB UL transmission. At step 803, the UE modifies the scheduled eMBB UL transmission based on the collision resolution.

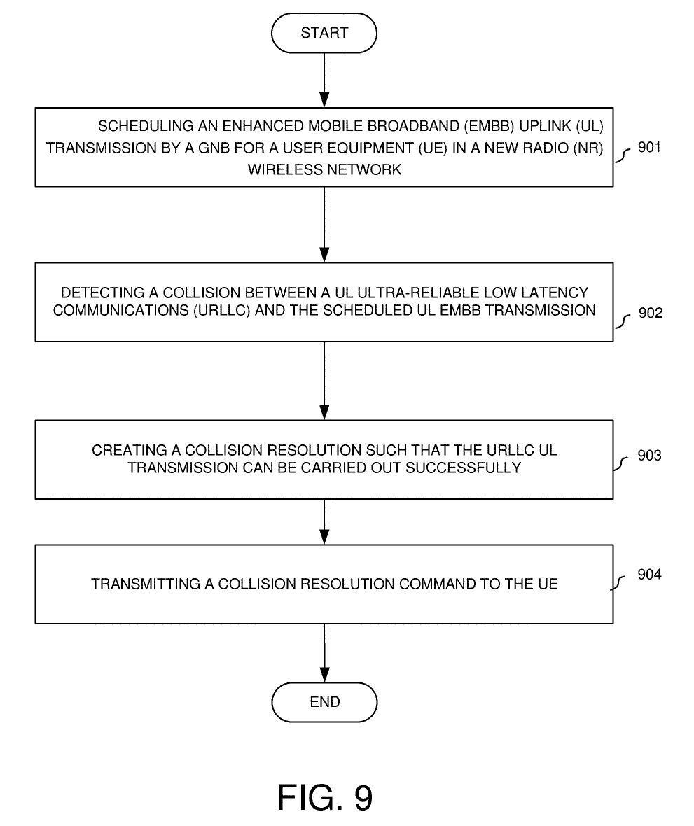

FIG. 9 illustrates an exemplary flow chart of the gNB URLLC and eMBB collision resolution in accordance with embodiments of the current invention. At step 901, the gNB schedules an eMBB UL transmission for a UE in a NR wireless network. At step 902, the gNB detects a collision between a UL URLLC and the scheduled UL eMBB transmission. At step 903, the gNB creates a collision resolution such that the URLLC UL transmission can be carried out successfully. At step 904, the gNB transmits a collision resolution command to the UE.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
scheduling an enhanced mobile broadband (eMBB) uplink (UL) transmission by a user equipment (UE) in a new radio (NR) wireless network;
subsequently initiating a collision resolution such that an ultra-reliable low latency communications (URLLC) uplink transmission can be carried out successfully, wherein the URLLC UL transmission collides with the scheduled eMBB UL transmission; and
modifying the scheduled eMBB UL transmission based on the collision resolution.

2. The method of claim 1, wherein the URLLC UL transmission is for the UE.

3. The method of claim 2, wherein UE transmission power is high enough to support both the UL eMBB and the UL URLLC transmissions, and wherein the modified UL eMBB transmission is puncturing the UL eMBB transmission based on predefined rules and transmitting both the UL URLLC and the UL eMBB.

4. The method of claim 2, wherein UE transmission power is not high enough to support both the UL eMBB and the UL URLLC, and wherein the modified UL eMBB transmission is one selecting from a modified-eMBB-transmission group comprising allocating enough power for the UL URLLC transmission while using remaining transmission power for the eMBB transmission, puncturing the UL eMBB transmission, and scaling down transmission power for both the UL URLLC transmission and the UL eMBB transmission.

5. The method of claim 1, wherein the URLLC UL transmission is from another UE.

6. The method of claim 5, wherein a collision resolution command is received from the NR wireless network to initiate the collision resolution.

7. The method of claim 5, wherein the collision resolution command is embedded in a downlink control information (DCI) specifying a transmit power control (TPC) offset larger than 3dB for an HARQ-ACK feedback or for a physical uplink share channel (PUSCH) transmission.

8. The method of claim 5, wherein the collision resolution command is a stop indicator to stop the UL eMBB transmission within a colliding time-frequency resource, and wherein the stop indicator is carried by one layer-1 (L1) signaling selecting from a L1 signaling group comprising a common downlink control information (DCI) and a new physical (PHY) channel.

9. A base station comprising:
a transceiver that transmits and receives radio signals in a new radio (NR) wireless system;
an uplink scheduling circuit that schedules an enhanced mobile broadband (eMBB) uplink (UL) transmission for a user equipment (UE) in the NR wireless network;
a collision detection circuit that detects a collision between a UL ultra-reliable low latency communications (URLLC) and the scheduled UL eMBB transmission; and
a collision resolution circuit that creates a collision resolution command such that the URLLC UL transmission can be carried out successfully and transmits a collision resolution command to the UE.

10. The base station of claim 9, wherein the URLLC UL transmission is from another UE.

11. The base station of claim 10, wherein the collision resolution command is embedded in a downlink control information (DCI) specifying a transmit power control (TPC) offset larger than 3 dB for an HARQ-ACK feedback or for a physical uplink share channel (PUSCH) transmission.

12. The base station of claim 10, wherein the collision resolution command is a stop indicator to stop the UL eMBB transmission within a colliding time-frequency resource, and wherein the stop indicator is carried by one layer-1 (L1) signaling selecting from a L1 signaling group comprising a common downlink control information (DCI) and a new physical (PHY) channel.

13. A user equipment (UE) comprising:
a transceiver that transmits and receives radio signals in a new radio (NR) wireless system;
an enhanced mobile broadband (eMBB) circuit that schedules an eMBB uplink (UL) transmission;
a collision resolution circuit that initiates a collision resolution such that an ultra-reliable low latency communications (URLLC) uplink transmission can be carried out successfully, wherein the URLLC UL transmission collides with the scheduled eMBB UL transmission; and
a transmission circuit that modifies the scheduled eMBB UL transmission based on the collision resolution.

14. The UE of claim 13, wherein the URLLC UL transmission is for the UE.

15. The UE of claim 14, wherein UE transmission power is high enough to support both the UL eMBB and the UL URLLC transmissions, and wherein the modified UL eMBB transmission is puncturing the UL eMBB transmission based on predefined rules and transmitting both the UL URLLC and the UL eMBB.

16. The UE of claim 14, wherein UE transmission power is not high enough to support both the UL eMBB and the UL URLLC, and wherein the modified UL eMBB transmission is one selecting from a modified-eMBB-transmission group comprising allocating enough power for the UL URLLC transmission while using remaining transmission power for the eMBB transmission, puncturing the UL eMBB transmission, and scaling down transmission power for both the UL URLLC transmission and the UL eMBB transmission.

17. The UE of claim 13, wherein the URLLC UL transmission is from another UE.

18. The UE of claim 17, wherein the collision resolution command is embedded in a downlink control information (DCI) specifying a transmit power control (TPC) offset larger than 3 dB for an HARQ-ACK feedback or for a physical uplink share channel (PUSCH) transmission.

19. The UE of claim 17, wherein the collision resolution command is a stop indicator to stop the UL eMBB transmission within a colliding time-frequency resource, and wherein the stop indicator is carried by one layer-1 (L1) signaling selecting from a L1 signaling group comprising a common downlink control information (DCI) and a new physical (PHY) channel.
